(19) United States
(12) Patent Application Publication
(10) Pub. No.: US 2023/0130819 A1
(43) Pub. Date: Apr. 27, 2023

(54) Process for manufacturing a solution of a fluorocopolymer

(71) Applicant: ARKEMA FRANCE, Colombes (FR)

(72) Inventors: Manuel HIDALGO, PIERRE-BENITE CEDEX (FR); Aristide LAJOUX, PIERRE-BENITE CEDEX (FR)

(73) Assignee: ARKEMA FRANCE, Colombes (FR)

(21) Appl. No.: 17/908,772

(22) PCT Filed: Mar. 3, 2021
(86) PCT No.: PCT/FR2021/050359

§ 371 Date: Sep. 1, 2022

(30) Foreign Application Priority Data
Mar. 3, 2020 (FR) 2002120

(51) Int. Cl. C08J 3/09; B01J 19/18

(52) U.S. Cl. CPC C08J 3/09; B01J 19/18; C08J 2327/16

(57) ABSTRACT

A process for manufacturing a solution of a fluorocopolymer in a solvent, the solvent having a boiling point above or equal to 150° C. at 1013 hPa and/or a saturation vapour pressure less than or equal to 5 hPa at 20° C., the process including a step of mixing said fluoropolymer with the solvent in a reactor having a stirring spindle including at least one blade, at a mixing temperature ranging from 40° C. to 100° C., and at a blade tip stirring speed of greater than or equal to 0.1 m/s, until said polymer has dissolved in the solvent. Also, a solution of the copolymer in this solvent that includes no co-solvent having a boiling point strictly below 150° C. at 1013 hPa and/or a saturation vapour pressure strictly greater than 5 hPa at 20° C.

### TECHNICAL FIELD

The invention relates to the field of fluoropolymers, in particular the solutions of copolymers derived from vinylidene fluoride and at least one other monomer.

### PRIOR ART

It is known from the prior art to manufacture solutions of P(VDF-TrFE) in sparingly volatile solvents, such as γ-butyrolactone (boiling point at 204.0° C.). The dispersion of P(VDF-TrFE) in γ-butyrolactone is nevertheless complex to carry out in practice.

It is for example known to mix the polymer with the solvent in the form of granules at a temperature of 180° C. under reflux for a period of 2 hours (cf. Zirkl, M., Stadlober, B., & Leising, G. (2007). Synthesis of ferroelectric poly (vinylidene fluoride) copolymer films and their application in integrated full organic pyroelectric sensors. Ferroelectrics, 353(1), 173-185). The disadvantage of this process is that it requires heating at high temperature, which is onerous to carry out and requires suitable equipment, and also appropriate safety measures. Moreover, such heating is the cause of a yellowing of the solution obtained, which is undesirable. Moreover, by proceeding according to this process, a gel is obtained at ambient temperature, and not a homogeneous solution. A homogeneous solution state is only obtained by slow heating of the gel from ambient temperature.

In order to work under milder temperature conditions, it has been proposed, for example in US2013/0153814, to mix P(VDF-TrFE) granules in a 50:50 mixture (volume proportions) of γ-butyrolactone:acetone for 24 hours under stirring with a magnetic stirrer at ambient temperature. Acetone, which is a much more volatile solvent than γ-butyrolactone, is also a solvent in which P(VDF-TrFE) dissolves more easily and more rapidly.

Owing to its high volatility, acetone is then easily evaporated at 40° C. by a rotary evaporator under reduced pressure. This process has the advantage of not subjecting the solution to high temperatures and does not lead to yellowing of the latter. Nevertheless, it has the disadvantage of using a co-solvent which will ultimately have to be eliminated during a dedicated additional step. Furthermore, the presence of residual amounts of co-solvent in the solution may be prejudicial for all uses leading to the manufacture of thin layers (films), and, in particular, those where the conditions for evaporating the solvent in order to form the thin layer are rapid (risk of appearance of continuity defects of the final film).

There is therefore a need to provide a process for manufacturing a solution of fluoropolymer in a solvent with a high boiling point and/or low saturation vapour pressure, in particular at quite high concentrations of fluoropolymer, that makes it possible to obtain a homogeneous solution, that limits the impurities (no volatile co-solvent), and that limits any degradation of the fluoropolymer or of the solvent.

Objectives

The objective of the present invention is to provide an improved process for manufacturing a solution of fluoropolymer in a solvent having a boiling point above or equal to 150° C. at 1013 hPa and/or a saturation vapour pressure less than or equal to 5 hPa at 20° C., this process enabling complete dissolution of the polymer in a reasonable time.

According to certain embodiments, one objective is to provide a process that is simpler to carry out than those of the prior art.

According to certain embodiments, one objective is to provide a process that is less expensive to carry out than those of the prior art.

According to certain embodiments, one objective is to provide a process that is faster to carry out than those of the prior art.

According to certain embodiments, one objective is to provide a process that makes it possible to obtain a composition that has virtually no yellowing.

According to certain embodiments, one objective is to provide a process that makes it possible to obtain a composition that has no volatile co-solvent, i.e. that has no co-solvent having a boiling point below or equal to 150° C. at 1013 hPa and/or a saturation vapour pressure greater than or equal to 5 hPa at 20° C.

### PRESENTATION OF THE INVENTION

The invention relates to a process for manufacturing a solution of a fluoropolymer in a solvent, the fluoropolymer being a polymer comprising units derived from vinylidene fluoride and also units derived from at least one other monomer of formula CX₁X₂=CX₃X₄, in which each X₁, X₂, X₃ and X₄ group is chosen independently from H, Cl, F, Br, I and alkyl groups comprising from 1 to 3 carbon atoms, which are optionally partially or completely halogenated,

the solvent having a boiling point above or equal to 150° C. at 1013 hPa and/or a saturation vapour pressure less than or equal to 5 hPa at 20° C.,

the process comprising a step of mixing said fluoropolymer with said solvent in a reactor having a stirring spindle comprising at least one blade, at a mixing temperature ranging from 40° C. to 100° C., and at a blade tip stirring speed of greater than or equal to 0.1 m/s, until said polymer has dissolved in said solvent. The inventors of the present invention have in fact observed that, surprisingly, the fluoropolymer, such as the P(VDF-TrFE) cited in the prior art, could be dissolved in a sparingly volatile solvent, such as γ-butyrolactone, without needing to use a co-solvent, or to excessively heat the mixture. The inventors have in fact selected a range of optimum temperatures and also defined an optimal stirring speed of a stirring spindle with blade(s) that make it possible to obtain a homogeneous fluoropolymer solution, in a simple, rapid and inexpensive manner.

According to certain embodiments, said at least one other monomer is chosen from: trifluoroethylene (TrFE), tetrafluoroethylene (TFE), 3,3,3-trifluoropropene, 1,3,3,3-tetrafluoropropene, 2,3,3,3-tetrafluoropropene, 1,3,3,3-tetrafluoropropene, 1,1,3,3,3-pentafluoropropene, 1,2,3,3,3-pentafluoropropene, hexafluoropropene (HFP), hexafluoroisobutylene (HFIB), perfluorobutylethylene, chlorotrifluoroethylene (CTFE), 1,1-chlorofluoroethylene (1,1-CFE), 1,2-chlorofluoroethylene (1,2-CFE), 2-chloro-3,3,3-trifluoropropene (1233xf), 1-chloro-3,3,3-trifluoropropene (1233zd), 1,2-dichloro-1,2-difluoroethylene, 1,1-dichloro-1,1-difluoroethylene and 1,1,2-trichloro-2-fluoroethylene.

According to certain embodiments, said fluoropolymer is chosen from: P(VDF-TrFE), P(VDF-TFE), P(VDF-TrFE-TFE), P(VDF-TrFE-CTFE), P(VDF-TrFE-CFE), P(VDF-TrFE-CTFE-CFE) and P(VDF-TrFE-TFE-CTFE-CFE). The fluoropolymer may in particular be chosen from: a P(VDF-TrFE), a P(VDF-TrFE-CFE), or a P(VDF-TrFE-CTFE).

According to certain embodiments, said fluoropolymer has a melt flow index (MFI), measured according to the standard ASTM D1238, at 230° C. and under a 10 kg load, of from 0.2 g/10 min to 20 g/10 min, preferentially from 0.5 to 10 g/10 min, more preferentially still from 0.8 g/10 min to 8 g/10 min, and extremely preferably between 1 g/10 min and 6 g/10 min.

According to certain embodiments, the solvent is chosen from the group consisting of: propylene glycol monomethyl ether acetate, N,N-dimethylformamide, cyclohexanone, N,N-dimethylacetamide, diacetone alcohol, diisobutyl ketone, 3-m ethylcyclohexanone, tetramethylurea, ethyl acetoacetate, dimethyl sulfoxide, trimethyl phosphate, diethylene glycol monoethyl ether, N-methyl-2-pyrrolidone, gamma-butyrolactone, isophorone, triethyl phosphate, carbitol acetate, propylene carbonate, dimethyl phthalate, and a mixture thereof. Preferentially, the solvent is chosen from the group consisting of propylene glycol monomethyl ether acetate, cyclohexanone, 3-methylcyclohexanone, dimethyl sulfoxide, gamma-butyrolactone, triethyl phosphate, and a mixture thereof.

According to certain embodiments, the solvent is gamma-butyrolactone or triethyl phosphate.

According to certain embodiments, the fluoropolymer represents from 1% by weight to 40% by weight of the total weight of the solution. Preferably, the fluoropolymer represents from 5% by weight to 30% by weight of the total weight of the solution. More preferably, the fluoropolymer represents from 10% by weight to 25% by weight of the total weight of the solution.

According to certain embodiments, the fluoropolymer represents more than 11%, or more than 12%, or more than 13%, or more than 14%, or else more than 15% by weight relative to the total weight of solution; and/or

less than 24%, or less than 23%, or less than 22%, or less than 21%, or else less than 20% by weight, relative to the total weight of solution.

According to certain embodiments, the mixing temperature is below or equal to 90° C., preferentially below or equal to 80° C., more preferentially below or equal to 70° C., and extremely preferably below or equal at 65° C.

According to certain embodiments, the blade tip stirring speed is greater than or equal to 0.25 m/s.

According to certain embodiments, the duration of the mixing step is between 30 minutes and 12 hours. Preferentially, the duration of the mixing step is between 1 hour and 5 hours.

According to certain embodiments, the stirring spindle comprises at least three blades, preferentially at least four blades.

According to certain embodiments, the characteristic internal diameter D of the reactor relative to the stirring diameter L of the stirring spindle is such that: 0.2D≤L≤0.9D; and,

preferably such that: 0.3D≤L≤0.8D.

According to certain embodiments, the mixing step is carried out by addition of the fluoropolymer, in a single go or in portions, to the solvent.

The invention also relates to the solution that can be obtained by the process according to the invention. In particular, the invention relates to a solution of a fluoropolymer in a solvent,

the fluoropolymer being a polymer comprising units derived from vinylidene fluoride and also units derived from at least one other monomer of formula CX₁X₂=CX₃X₄, in which each X₁, X₂, X₃ and X₄ group is chosen independently from H, Cl, F, Br, I and alkyl groups comprising from 1 to 3 carbon atoms, which are optionally partially or completely halogenated, the solvent having a boiling point above or equal to 150° C. at 1013 hPa and/or a saturation vapour pressure greater than or equal to 5 hPa at 20° C. This solution is characterized in that it does not comprise a co-solvent of said fluoropolymer having a boiling point strictly below 150° C. at 1013 hPa and/or a saturation vapour pressure strictly greater than 5 hPa at 20° C.

According to certain embodiments, the solution has a viscosity, as measured at ambient temperature (25° C.) using a Brookfield RVDV-II+P viscometer, of from 2000 mPa·s to 40 000 mPa·s, preferentially from 8000 mPa·s to 30 000 mPa·s, more preferably from 12 000 mPa·s to 28 000 mPa·s, and extremely preferably from 15 000 mPa·s to 25 000 mPa·s.

According to particular embodiments, the solution may have a viscosity of from 18 000 mPa·s to 24000 mPa·s.

According to certain embodiments, said fluoropolymer and/or the solvent and/or the amount of fluoropolymer in the solution is as described above.

### LIST OF FIGURES

FIG. 1 represents a single-stage four-bladed stirring spindle, in perspective view.

FIG. 2 represents the two-stage four-bladed stirring spindle used in Example 2, in side view.

FIG. 3 represents the same stirring spindle as the one from FIG. 2, in top view.

### DETAILED DESCRIPTION OF THE INVENTION

The invention is now described in greater detail and in a nonlimiting manner in the description which follows.

In the present patent application, the expression “a fluoropolymer” should be understood as meaning “one or more fluoropolymers”. The same applies to all the other cases in point. Thus, for example, the expression “a solvent” should be understood as meaning “one or more solvents”.

Fluoropolymer

The polymer is a copolymer (in the broad sense): it comprises units derived from (i.e. which are obtained by polymerization of) the vinylidene fluoride (VDF) monomer and at least one monomer X other than vinylidene fluoride. A single monomer X may be used, or a plurality of different monomers X, as appropriate. The monomer X is of formula: CX₁X₂=CX₃X₄,

in which each X₁, X₂, X₃ and X₄ group is chosen independently from H, Cl, F, Br, I and C1-03 (preferably C1-C2) alkyl groups, which are optionally partially or completely halogenated. The monomer X is different from VDF, i.e. if X₁ and X₂ represent H, then at least one of X₃ and X₄ does not represent F, and conversely if X₁ and X₂ represent F, at least one of X₃ and X₄ does not represent H.

In some embodiments, each X₁, X₂, X₃ and X₄ group independently represents an H, F, Cl, I or Br atom or a methyl group optionally containing one or more substituents selected from F, Cl, I and Br.

In certain embodiments, each X₁, X₂, X₃ and X₄ independently represents an H, F, Cl, I or Br atom.

In certain embodiments, only one of the X₁, X₂, X₃ and X₄ represents a Cl or I or Br atom, and the others of the X₁, X₂, X₃ and X₄ groups independently represent: an H or F atom or a C1-C3 alkyl group optionally containing one or more fluorine substituents; preferably, an H or F atom or a C1-C2 alkyl group optionally containing one or more fluorine substituents; and more preferably, an H or F atom or a methyl group optionally containing one or more fluorine substituents. Examples of monomers X comprising only fluorine as halogen atom are: vinyl fluoride (VF), trifluoroethylene (TrFE), tetrafluoroethylene (TFE), hexafluoropropene (HFP), trifluoropropenes and in particular 3,3,3-trifluoropropene, tetrafluoropropenes and in particular 2,3,3,3-tetrafluoropropene or 1,3,3,3-tetrafluoropropene (in the cis or, preferably, trans form), hexafluoroisobutylene, perfluorobutylethylene, pentafluoropropenes and in particular 1,1,3,3,3-pentafluoropropene or 1,2,3,3,3-pentafluoropropene, perfluoroalkyl vinyl ethers and in particular those of general formula R_{f}—O—CF=CF₂, in which Rf is an alkyl group, preferably a C1 to C4 alkyl group (preferred examples being perfluoropropyl vinyl ether (PPVE), and perfluoromethyl vinyl ether (PMVE)).

Examples of monomer X comprising at least one chlorine or bromine atom are: bromotrifluoroethylene, 1-chloro-1-fluoroethylene (CFE), 1-chloro-2-fluoroethylene, chlorotrifluoroethylene (CTFE), 2-chloro-3,3,3-trifluoropropene (1233xf), 1-chloro-3,3,3-trifluoropropene (in the cis or trans, preferably trans, form), 1,2-dichloro-1,2-difluoroethylene, 1,1-dichloro-1,1-difluoroethylene and 1,1,2-trichloro-2-fluoroethylene.

In certain preferred embodiments the fluoropolymer comprises units derived from VDF and HFP or else is a P(VDF-HFP) polymer consisting of units derived from VDF and HFP. The molar proportion of repeat units derived from HFP is preferably from 2% to 50%, in particular from 5% to 40%.

In certain preferred embodiments, the fluoropolymer comprises units derived from VDF and CFE, and/or from CTFE, and/or from TFE, and/or from TrFE. The molar proportion of repeat units derived from monomers other than VDF is preferably less than 50%.

In certain preferred embodiments, the fluoropolymer comprises units derived from VDF and TrFE, or else is a P(VDF-TrFE) polymer consisting of units derived from VDF and TrFE.

In certain preferred embodiments, the fluoropolymer comprises units derived from VDF, TrFE and another monomer X as defined above, different from VDF and from TrFE, or else is a P(VDF-TrFE-X) polymer consisting of units derived from VDF, TrFE and another monomer X as defined above, which is different from VDF and from TrFE. In this case, preferably, the other monomer X is selected from TFE, HFP, trifluoropropenes and in particular 3,3,3-trifluoropropene, tetrafluoropropenes and in particular 2,3,3,3-tetrafluoropropene or 1,3,3,3-tetrafluoropropene (in cis, or, preferably, trans form), bromotrifluoroethylene, chlorofluoroethylene, chlorotrifluoroethylene and chlorotrifluoropropene. CTFE or CFE are particularly preferred.

When units derived from VDF and from TrFE are present, the proportion of units derived from TrFE is preferably from 5 to 95 mol %, relative to the sum of the units derived from VDF and TrFE, and in particular: from 5 to 10 mol %; or from 10 to 15 mol %; or from 15 to 20 mol %; or from 20 to 25 mol %; or from 25 to 30 mol %; or from 30 to 35 mol %; or from 35 to 40 mol %; or from 40 to 45 mol %; or from 45 to 50 mol %; or from 50 to 55 mol %; or from 55 to 60 mol %; or from 60 to 65 mol %; or from 65 to 70 mol %; or from 70 to 75 mol %; or from 75 to 80 mol %; or from 80 to 85 mol %; or from 85 to 90 mol %; or from 90 to 95 mol %. A range from 15 to 55 mol. % is particularly preferred.

When units derived from another monomer X, in addition to VDF and TrFE, are present (the monomer X being in particular CTFE or CFE), the proportion of units derived from this other monomer X in the fluoropolymer (relative to the entirety of the units) may vary, for example, from 0.5 to 1 mol %; or from 1 to 2 mol %; or from 2 to 3 mol %; or from 3 to 4 mol %; or from 4 to 5 mol %; or from 5 to 6 mol %; or from 6 to 7 mol %; or from 7 to 8 mol %; or from 8 to 9 mol %; or from 9 to 10 mol %; or from 10 to 12 mol %; or from 12 to 15 mol %; or from 15 to 20 mol %; or from 20 to 25 mol %; or from 25 to 30 mol %; or from 30 to 40 mol %; or from 40 to 50 mol %. Ranges from 1 to 20 mol %, and preferably from 2 to 15 mol %, are particularly suitable.

The molar composition of the units in the fluoropolymers may be determined by various means such as infrared spectroscopy or RAMAN spectroscopy. Conventional methods of elemental analysis of carbon, fluorine and chlorine or bromine or iodine elements, such as X-ray fluorescence spectroscopy, make it possible to calculate the mass composition of the polymers, from which the molar composition is deduced.

Use may also be made of multinuclear NMR techniques, in particular proton (1H) and fluorine (19F) NMR techniques, by analysis of a solution of the polymer in an appropriate deuterated solvent.

Finally, it is possible to combine elemental analysis, for example for the heteroatoms, such as chlorine or bromine or iodine, and NMR analysis. Accordingly, the content of units obtained from CTFE, in a P(VDF-TrFE-CTFE) terpolymer for example, may be determined by measuring the chlorine content by elemental analysis.

The melt flow index (MFI) makes it possible to characterize an average molecular mass indirectly. The MFI may be measured according to the standard ASTM D1238, using equipment such as the Dynisco D4059 B Flowmeter, by determining the cumulative weight that passes through the measurement die after 10 minutes when the machine is operated at 230° C. and 10 kg of load on the molten polymer. According to certain variants, the fluoropolymer has an MFI between 0.2 g/10 min and 20 g/10 min under these conditions, preferably between 0.5 g/10 min and 10 g/10 min, more preferentially still between 0.8 g/10 min and 8 g/10 min and extremely preferably between 1 g/10 min and 6 g/10 min.

The fluoropolymer is preferably random and linear.

The fluoropolymer may be homogeneous or heterogeneous. A homogeneous polymer has a uniform chain structure, the statistical distribution of the units derived from the various monomers varying very little between the chains. In a heterogeneous polymer, the chains have a distribution of units derived from the various monomers of multimodal or spread-out type. A heterogeneous polymer therefore comprises chains that are richer in a given unit and chains poorer in this unit.

The fluoropolymer may be in the form of pieces, granules or in powder form. Preferentially, the fluoropolymer is in powder form or in the form of granules.

Solvent

A “solvent of the polymer” is understood to mean a liquid that enables the dissolution of the polymer.

The “dissolution” of a fluoropolymer in a solvent of the polymer, is understood to mean that a homogeneous dispersion of the polymer in the solvent is obtained: the polymer particles, more or less swollen with solvent, are dispersed in a continuous solvent phase.

The homogeneity of the dispersion may be confirmed macroscopically (i.e. by observing with the naked eye that the dispersion is indeed of homogeneous appearance), by observing that the dispersion does not have a granular or macro-separated appearance. The term “homogeneous dispersion” is thus used in contrast with a “heterogeneous dispersion”, i.e. a dispersion with a partially granular macroscopic appearance or having a macroscopically visible phase separation, such as a gel.

The homogeneity may alternatively be assessed quantitatively by measuring the solids content of fractions of the dispersion. For these purposes, fractions of a few millilitres may be sampled from a much larger volume of solution, for example 100 ml, or preferably 500 ml or 1 l, or even more. For each fraction of a few millilitres, the solids content is determined by evaporation of the solvent, which involves recording the mass of the sample before and after the evaporation operation. The solvent is evaporated as completely as possible by evaporation techniques known to those skilled in the art such as evaporation in an oven at a given temperature and for a long enough time, at atmospheric pressure or under reduced pressure. By way of indication, in a ventilated oven at atmospheric pressure, a temperature of 140° C. and an evaporation time of at least 2 hours are sufficient for the evaporation, on a few millilitres of solution, of solvents such as those of the invention. The solids contents of the fractions (at least two of them, and preferably between 3 and 10), may thus be compared with one another in order to detect a possible inhomogeneity.

The solubility of the polymer in a given liquid may be determined by adding an amount of polymer of 5% weight/weight to said liquid at ambient temperature (25° C.), by stirring, if necessary by heating moderately at a temperature below or equal to 60° C. (for example at a temperature of 60° C.), for 15 or 60 minutes (for example for 60 minutes), then by leaving to cool to ambient temperature (25° C.) and by visually observing, at this temperature, after 15 or 60 minutes (for example after 60 minutes), whether or not any solid polymer remains in suspension.

A process for selecting solvents suitable for fluoropolymers, that can be applied to the polymers of the solutions according to the invention, was described in patent application WO19170999. This selection process makes it possible in particular to easily identify which liquids are suitable as solvents for the dissolution of fluoropolymers, by only carrying out a limited number of dissolution experiments. The boiling point of a pure substance at a given pressure is the temperature at which the vapour pressure is equal to the atmospheric pressure. The solvent has a boiling point above or equal to 150° C. at 1013 hPa. According to certain embodiments, the solvent has a boiling point above or equal to 160° C., or above or equal to 170° C., or above or equal to 180° C., or above or equal to 190° C. or else above or equal to 195° C., at 1013 hPa.

Alternatively, or in addition, the solvent has a saturation vapour pressure lower than or equal to 5.0 hPa at 20° C. The saturation vapour pressure at a given temperature is the pressure at which the gaseous phase of a substance is in equilibrium with its liquid or solid phase at this temperature. According to certain embodiments, the solvent has a vapour pressure of less than or equal to 4.5 hPa, or less than or equal to 4.0 hPa, or less than or equal to 3.5 hPa, or less than or equal to 3.0 hPa, or less than or equal to 2.5 hPa, or less than or equal to 2.0 hPa, or less than or equal to 1.5 hPa, or less than or equal to 1.0 hPa, or else less than or equal to 0.5 hPa, at 20° C.

The solvent of the solution according to the invention may in particular be chosen from the list presented in Table 1 below, or a mixture thereof:

TABLE 1

| Solvent | CAS no. | BP (° C.) | Pₛₐₜ (hPa) |
|---|---|---|---|
| Propylene glycol | 108-65-6 | 146 | 4.93 (at |
| monomethyl ether | | | 20° C.) |
| acetate (PGMEA) | | | |
| N,N- | 68-12-2 | 153 | 3.8 (at |
| Dimethylformamide | | | 20° C.) |
| (DMF) | | | |
| Cyclohexanone | 108-84-1 | 155.65 | 5 (at 20° C.) |
| N,N- | 127-19-5 | 166 | 1.76 (at |
| Dimethylacetamide | | | 20° C.) |
| (DMAc) | | | |
| Diacetone alcohol | 123-42-2 | 167 | 1.08 (at |
| | | | 20° C.) |
| Diisobutyl ketone | 108-83-8 | 169 | 3.3 (at |
| (DIBK) | | | 20° C.) |
| 3- | 591-24-2 | 169-170 | 1.3 at 25° C. |
| Methylcyclohexanone | | | |
| Tetramethylurea | 632-22-4 | 177 | 13.3 (at |
| | | | 61° C.) |
| Ethyl acetoacetate | 141-97-9 | 180 | 1.0 (at |
| | | | 20° C.) |
| Dimethyl sulfoxide | 67-68-5 | 189 | 0.59 (at |
| | | | 20° C.) |
| Trimethyl phosphate | 512-56-1 | 195 | 1.1 (at |
| (TMP) | | | 20° C.) |
| Diethylene glycol | 111-90-0 | 201.9 | 0.15 (at |
| monoethyl ether | | | 20° C.) |
| N-Methyl-2- | 212-828-1 | 202 | 0.4 (at |
| pyrrolidone (NMP) | | | 20° C.) |
| Gamma- | 96-48-0 | 204 | 0.15 (at |
| butyrolactone | | | 20° C.) |
| Isophorone | 78-59-1 | 215 | 0.4 (at |
| | | | 20° C.) |
| Triethyl phosphate | 78-40-0 | 215 | 0.2 (at |
| | | | 20° C.) |
| Carbitol acetate | 112-15-2 | 217 | 0.13 (at |
| | | | 20° C.) |
| Propylene carbonate | 108-32-7 | 242 | 0.06 (at |
| | | | 25° C.) |
| Dimethyl phthalate | 131-11-3 | 282 | 0.08 (at |
| | | | 20° C.) |

Facility and Process

The process for manufacturing a solution of the fluoropolymer is carried out, at least during the step of mixing the fluoropolymer with the solvent, in a stirred tank, hereinafter referred to as “reactor” even though no chemical reaction takes place therein, having a stirring spindle comprising at least one blade.

The reactor may for example be a glass reactor, a reactor in which the internal wall is made of glass or else a reactor made of stainless metal materials, or coated with PTFE or any other fluoropolymer.

The reactor advantageously has a cylindrical shape, with a characteristic internal diameter D.

The reactor is advantageously of vertical type.

The stirring spindle may be centred or slightly off-centred within the reactor. In the case where the stirring spindle is centred, the reactor may optionally comprise, on its external walls, counter blades.

The monitoring of the temperature of the reactor and the contents thereof may be carried out by various means, well known to those skilled in the art. One simple means of ensuring that the interior of the reactor is under isothermal or quasi-isothermal conditions is for example to use a jacketed reactor and to circulate through the jacket a heat-transfer fluid, the temperature of which is regulated.

The stirring spindle comprises at least one blade capable of rotating about an axis of rotation. Thus, a blade-tip speed may be defined as being the speed of the most distant point of the blade relative to the axis of rotation.

The blade-tip speed, Vₜ, of the stirring spindle may be calculated from the formula:

Vₜ=2π·N·r, [Math 1]

where N is the stirring speed in revolutions per unit of time and r is the distance between the axis of the spindle and the blade tip.

There are a large number of stirring spindles known to those skilled in the art. Stirring spindles suitable for dispersion and/or for relatively viscous media are particularly suitable for the process according to the invention.

A nonlimiting list of basic stirring spindles is given in Table 3-1, page 59 of the book by James Y. Oldshue: FLUID MIXING TECHNOLOGY. New York: McGraw Hill © 1983.

In certain embodiments, the stirring spindle generates mainly axial flow.

In certain embodiments, the stirring spindle generates mainly radial flow.

In certain embodiments, the stirring spindle generates tangential flow.

In certain embodiments, the stirring spindle generates axial flow and radial flow. The stirring spindle preferably does not generate mainly tangential flow.

The stirring spindle may have various shapes and names, it may be, non-limitingly, of impeller type, a blade agitator, an anchor, a turbine (such as for example a Rushton turbine), a blade rotor or a propeller. Preferably, the spindle is a blade agitator or a propeller or else a twisted-blade impeller, sometimes referred to as a centrifugal impeller turbine.

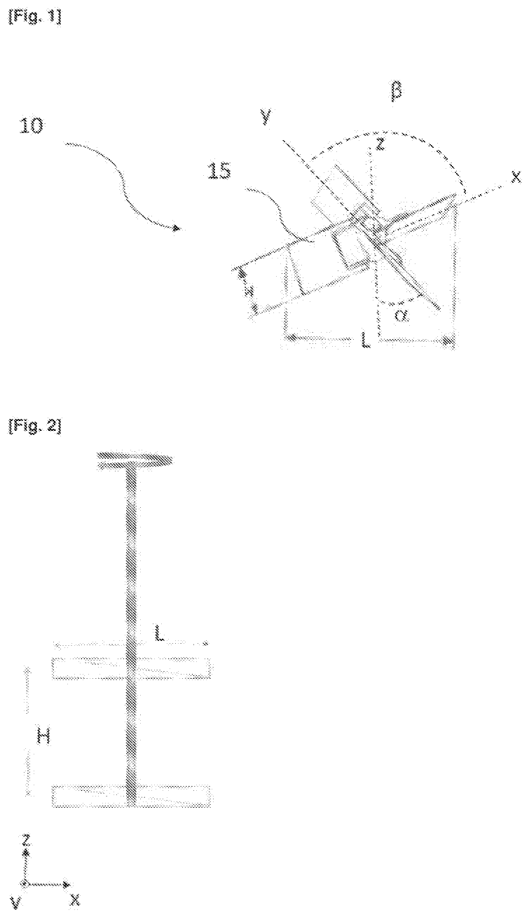

The stirring spindle may advantageously be based on pitched blades of “A-2” type from the abovementioned nonlimiting list, as represented in FIG. 1.

With reference to FIG. 1, the stirring spindle 10 comprises four blades 15. The blades 15 are straight and are arranged in a cross shape in the (xy) plane (angle β between two successive blades in the (xy) plane equal to 90°) all pitched in the same direction by an angle α (α=0° means that a normal to the blade plane is perpendicular to the z axis; α=90° means that a normal to the blade plane is collinear with the z axis). The width W of the blades 15 relative to the stirring diameter L, defined as being L=2·r, is such that L=5W.

In certain embodiments, the stirring spindle used in the invention is a spindle directly obtained by variations of certain parameters of the spindle presented in FIG. 1, such as for example:
the number n of blades of the stirring spindle, such that:

1≤n≤8, [Math 2]

and preferentially such that:

3≤n≤6; [Math 3]

the angle β is advantageously equal to: (360/n)°;
the angle α, such that:

0°≤α≤80°, [Math 4]

and preferentially such that:

30°≤α≤60°; [Math 5]
the shape of the blades: the blades may adopt a shape different from a straight blade, in particular they may be curved;
the width W of the blades relative to the stirring diameter L, such that:

1.5W≤L≤8W, [Math 6]

and preferentially such that:

2W≤L≤7W; [Math 7]
the characteristic internal diameter D of the reactor relative to the stirring diameter L of the stirring spindle may be such that:

0.2D≤L≤0.9D, [Math 8]

and preferably such that:

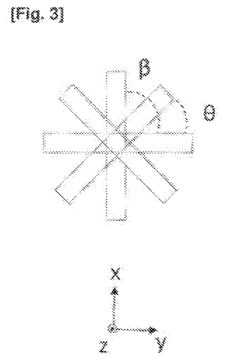

0.3D≤L≤0.8D, [Math 9]

where D is the characteristic internal diameter of the reactor;
the number of stages: several blades of the same type or of different type may be mounted on a same axis at different heights, as illustrated with the stirring spindle according to FIGS. 2 and 3; preferably the stages are separated by a centre-to-centre distance H (see FIG. 2, side view) of between 0.8 L and 1.2 L; also preferably, the stages have an angular offset θ (see FIG. 3, top view), minimizing the superposition of the blades between one stage and another: for example, for an agitator with two stages, each having a spindle with 2 aligned blades, the stages advantageously have a a preferred angular offset of around 90° and for an agitator having two stages with spindles having 4 blades, the stages advantageously have a preferred angular offset of around 45°.

The stirring spindle represented in FIG. 2 and in FIG. 3 was used in Example 2 of the process according to the invention. The stirring spindle is of 2-stage, four-blade type. The blades of each stage form a cross (β=90°) and extend over a stirring diameter L=5.5 cm. The blades are pitched in the same direction by an angle α equal to 45° so as to promote pumping from the top to the bottom of the reactor. The distance H between the two stages is equal to 4.5 cm. The width W of the blades is 2 cm. The angular offset θ between the blades of the two stages is 45°. The diameter of the shaft of the agitator is 1 cm.

One nonlimiting embodiment of the process comprises the steps, or at least some of the steps, below:

It comprises a step of filling the reactor with the solvent so as to obtain a solvent-filled reactor. The solvent level in the reactor is adapted as a function of the total capacity of the reactor and of the stirring spindle used.

The stirring spindle of the reactor is switched on and also the temperature control system so that the solvent is stirred and maintained in a desired temperature range.

The fluoropolymer is then added to the solvent which defines the mixing step. The mixing step is carried out in the absence of a co-solvent of said fluoropolymer having a boiling point strictly below 150° C. at 1013 hPa and/or a saturation vapour pressure strictly greater than 5 hPa at 20° C.

The polymer may be added in one go to the solvent, more or less rapidly, or alternatively in several goes in portions. The first addition of polymer to the solvent constitutes the start of the mixing step.

In the embodiment in which the fluoropolymer is added in portions to the solvent, it may be advantageous to add each new portion once the previous portion has been completely dispersed.

The temperature of the mixture of fluoropolymer with the solvent is maintained at a temperature ranging from 40° C. to 100° C. throughout the duration of the mixing step. Below a temperature of 40° C., it is considered that the dispersion kinetics will be too slow to enable a dispersion in a reasonable time. The temperature of the mixture may be maintained at a temperature above or equal to 45° C., and preferentially above or equal to 50° C.

Above 100° C., it is considered that the thermal degradation of the fluoropolymer and/or of the solvent becomes too great. The temperature of the mixture may be maintained at a temperature below or equal to 90° C., preferentially below or equal to 80° C., more preferentially below or equal to 70° C., and extremely preferably below or equal at 65° C.

In preferred embodiments, the temperature of the mixture is maintained at a temperature ranging from 50° C. to 65° C. during the mixing step.

The mixing step is implemented under stirring with a blade tip speed of the stirring spindle of greater than or equal to 0.1 m/s. Below a blade tip speed of 0.1 m/s, it is considered that the dispersion kinetics will be too slow to enable a dispersion in a reasonable time.

In preferred embodiments, the blade tip speed is greater than or equal to 0.25 m/s. The blade tip speed may in particular be greater than or equal to 0.30 m/s, or greater than or equal to 0.35 m/s, or greater than or equal to 0.45 m/s, or greater than or equal to 0.5 m/s, or else greater than or equal to 1 m/s. The blade tip speed does not generally exceed 10 m/s.

In certain embodiments, the temperature of the mixture is maintained at a temperature ranging from 50° C. to 65° C. and under stirring with a blade tip speed of the stirring spindle ranging from 0.25 m/s to 10 m/s during the mixing step.

The mixing step may end (at the earliest) once all the fluoropolymer has been added to the solvent and has been dispersed so as to form a dispersion that is homogeneous, at least macroscopically. The duration of the mixing step is between 30 minutes and 12 hours. In preferred embodiments, it may be between 1 hour and 5 hours.

The stirring spindle of the reactor may then be stopped and also the temperature control system.

When additives must be added to form the solution according to the invention, they may be added before, during or after the dispersion of the fluoropolymer in the solvent. The additive(s) may in particular be chosen from surface tension modifiers, rheology modifiers, ageing resistance modifiers, adhesion modifiers, pigments or dyes, and fillers (including nanofillers).

Solution

The dissolution of polymer in a solvent makes it possible to obtain a “solution”. The term “solution” is used here in contrast with a suspension of polymer particles in a liquid vehicle, for example a gel, and in contrast with a polymer emulsion or latex, which is a colloidal dispersion. A solution, owing to the mixing on the molecular level, is of homogeneous and completely transparent appearance, unlike a suspension (inhomogeneous appearance, with visible presence of grains in suspension), an emulsion (heterogeneous, cloudy, opalescent or opaque appearance) or a latex or colloidal dispersion (opalescent or bluish or cloudy or milky appearance).

This solution is advantageously of homogeneous and completely transparent appearance, at ambient temperature, i.e. in particular between 15° C. and 35° C., and in particular at 25° C.

The solution comprises no co-solvent of said fluoropolymer having a boiling point strictly below 150° C. at 1013 hPa and/or a saturation vapour pressure strictly greater than 5 hPa at 20° C. This means that the solution comprises no such co-solvents, even in trace amounts.

The solution comprises in particular no traces of acetone, trichloroethane or methoxycyclopentane.

In certain embodiments, additives may be added (partially soluble polymers, nano fillers) which lead to non-transparent “solutions”. The term “solutions” is retained here, even though these are, strictly speaking, slightly cloudy nanodispersions or microdispersions, which nevertheless retain their macroscopic homogeneity as can be verified by the solids content test described above.

Thus, the solution may consist of said at least one fluoropolymer, of one or more solvents having a boiling point above or equal to 150° C. at 1013 hPa and/or a saturation vapour pressure less than or equal to 5 hPa at 20° C., and optionally of one or more additives.

The process according to the invention makes it possible to obtain homogeneous solutions that are relatively concentrated in fluoropolymer, in a reasonable time (in particular less than or equal to 12 hours). In certain embodiments, the solution may comprise from 1% by weight to 40% by weight of fluoropolymer relative to the total weight of solution. Preferably, the solution may comprise from 5% by weight to 30% by weight of fluoropolymer relative to the total weight of solution. More preferably, the solution may comprise from 10% by weight to 25% by weight of fluoropolymer relative to the total weight of solution.

The solution may in particular comprise more than 11%, or more than 12%, or more than 13%, or more than 14%, or else more than 15% by weight of fluoropolymer relative to the total weight of solution; and/or

less than 24%, or less than 23%, or less than 22%, or less than 21%, or else less than 20% by weight of fluoropolymer relative to the total weight of solution.

In the embodiments where the manufactured solution comprises additives, the latter generally represent less than 15% by weight, and more preferably less than 10% by weight of the total weight of solution.

According to certain embodiments, the solution has a viscosity, as measured at ambient temperature (25° C.) using a Brookfield RVDV-II+P viscometer, of from 2000 mPa·s to 40 000 mPa·s, preferentially from 8000 mPa·s to 30 000 mPa·s, more preferably from 12 000 mPa·s to 28 000 mPa·s, and extremely preferably from 15 000 mPa·s to 25 000 mPa·s.

According to particular embodiments, the solution may have a viscosity of from 18 000 mPa·s to 24 000 mPa·s.

Application

A thin film of fluoropolymer may be obtained by depositing then drying (evaporation of the solvent) a solution according to the invention (ink) of relatively high viscosity.

Screen printing consists of spreading an ink on a screen-printing screen or mesh bearing the pattern to be printed, onto a suitable support. The screen is placed on the support and the ink is spread using a squeegee; next, the screen is raised and the support bearing the liquid layer of ink that has passed through the screen is left to dry. After evaporation of the solvent, during the drying, a (“dry”) solid thin film having the pattern defined by the screen remains printed on the support. The polymer film may thus be deposited on a carrier, a substrate (e.g. plastic, metal, glass, wood, paper, etc.), an optoelectronic device (photovoltaic cell, part or all of a transistor, electrode, sensor, actuator, etc.) in order to ultimately constitute, in its solid form, an integral part of an optoelectronic device, for example, as active dielectric layer (for instance a layer that emits or receives a mechanical signal), or a passive dielectric layer (for instance a dielectric layer with a high dielectric constant).

### EXAMPLES

### Example 1: Liquids that May be Chosen as Solvents

This example repeats the example developed in application WO19170999 and shows how the solubility of a fluoropolymer in any liquid can be estimated from a known set of training data.

A set of training data was established from Table 2 below:

TABLE 2

| Liquid | δ_{d} | δₚ | δₕ | Solubility |
|---|---|---|---|---|
| Methyl ethyl ketone (2) | 14.1 | 9.3 | 9.5 | Yes |
| Methyl ethyl ketone (5) | 16 | 9 | 5.1 | Yes |
| Dimethyl sulfoxide (5) | 18.4 | 16.4 | 10.2 | Yes |
| Triethyl phosphate (5) | 16.8 | 11.5 | 9.2 | Yes |
| Ethyl acetate (2) | 13.4 | 8.6 | 8.9 | Yes |
| Ethyl acetate (5) | 15.8 | 5.3 | 7.2 | Yes |
| Cyclohexanone (2) | 15.6 | 9.4 | 11 | Yes |
| Cyclohexanone (5) | 17.8 | 6.3 | 5.1 | Yes |
| Cyclopentanone (2) | 16.2 | 11.1 | 8.8 | Yes |
| γ-butyrolactone (2) | 18.6 | 12.2 | 14 | Yes |
| γ-butyrolactone (5) | 19 | 16.6 | 7.4 | Yes |
| Acetone (2) | 13 | 9.8 | 11 | Yes |
| Acetone (5) | 15.5 | 10.4 | 7 | Yes |
| Tetrahydrofuran (2) | 13.3 | 11 | 6.7 | Yes |
| Tetrahydrofuran (5) | 16.8 | 5.7 | 8 | Yes |
| N,N-Dimethylformamide (5) | 17.4 | 13.7 | 11.3 | Yes |
| N,N-Dimethylacetamide (5) | 16.8 | 11.5 | 10.2 | Yes |
| Pyridine (2) | 17.6 | 10.1 | 7.7 | Yes |
| Pyridine (5) | 19 | 8.8 | 5.9 | Yes |
| Ethanol (2) | 12.6 | 11.2 | 20 | No |
| Glycerol (2) | 9.3 | 15.4 | 31.4 | No |
| Isopropanol (2) | 14 | 9.8 | 16 | No |
| Isopropanol (5) | 15.8 | 6.1 | 16.4 | No |
| Benzyl alcohol (5) | 18.4 | 6.3 | 13.7 | No |
| Benzaldehyde (5) | 19.4 | 7.4 | 5.3 | No |

In this table, the Hansen solubility parameters are given in MPa^{1/2}. The notations (2) or (5) indicate that these Hansen solubility parameters originate either from Table 2 in Chapter 7 or from Table 5 in Chapter 8 of the CRC Handbook of Solubility Parameters and Other Cohesion Parameters, by Allan F. M. Barton, 2nd Edition (1991).

The information relating to the solubility (yes/no) was obtained experimentally with a P(VDF-TrFE) polymer comprising 80% of VDF units and 20% of TrFE units (in molar proportions).

The JMP 13.0.0 software from the company SAS was used to provide a neural network as depicted in FIG. 1. 20 lines of the table were used for training the model and 6 for the validation. The success rate obtained is 100%.

The “KFold” validation method was used. This method, as explained by the software manual, divides the data into K subgroups. Successively, each of the K subgroups is used to validate the fit or the model created, with the remainder of the data not included in the subgroup K, which makes it possible to obtain K different models. The model having the best statistical validation (lowest error) is chosen as the final model.

From this modelling, the following predictive model was obtained.

Functions of the three neurones of the hidden layer:

H1=tanh(0.5×(0.288078×δd+0.029058×δp+0.092642×δh−4.79788));

−H2=tanh(0.5×(0.131723×δd−0.16692×δp−0.03299×δh−0.05098));

−H3=tanh(0.5×(0.399484×δd−0.11103×δp−0.05299×δh−4.13038)).

In the foregoing, the Hansen solubility parameters are expressed in MPa^{1/2}.

Function of the output neurone:S=exp(201.3275×H1+192.4403×H2−156.203×H3−82.4311).

The probability of insolubility is S/(1+S) and the probability of solubility is: (1−probability of insolubility).

The model thus obtained may be applied to any new solvent not present in the preceding training table. Thus, for example, Table 3 below gives the following responses for 3 new solvents unknown to the model.

TABLE 3

| | | | | Probability |
|---|---|---|---|---|
| Solvent | δ_{d} | δₚ | δₕ | of solubility |
| PGMEA | 15.5 | 5.5 | 9.8 | 0.999975366 |
| 3-methylcyclohexanone | 17.7 | 6.3 | 4.7 | 0.999999998 |
| 1-octanol | 16 | 3.3 | 11.9 | 6.00075E−10 |

Experimentation confirms that a P(VDF-TrFE) polymer comprising 80% of VDF units and 20% of TrFE units (in molar proportions) is soluble in propylene glycol monomethyl ether acetate (PGMEA) and 3-methylcyclohexanone, but not in 1-octanol.

### Example 2: Process According to the Invention for the Manufacture of a Solution of P(VDF-TrFE) in Triethyl Phosphate—Stirring Spindle of Four-Blade Type

The assembly used comprises a vertical reactor with an internal diameter D equal to 10 centimetres, which is jacketed, made of glass, has a maximum capacity of 2 litres and is equipped with a cover in the centre through which a stirring spindle, connected to a motor, passes.

The jacket is connected to a circuit for heating/cooling using a heat-transfer fluid emanating from a thermostatically-controlled bath.

The cover comprises stoppers that enable:
the inlet of material (for introducing the solvent and the polymer);
the connection to a vapour condensation/reflux system;
the passage of perforated hollow tubes for bubbling of an inert gas such as nitrogen, and/or of unperforated hollow tubes for introducing a thermocouple probe.

The reactor has a bottom valve in order to drain off the polymer solution.

The stirring spindle is the one represented in FIGS. 2 and 3, as described above. Its L/D ratio is equal to 0.55. The agitator is centred and placed close to the bottom of the reactor for the operation at a typical distance of 5 cm from the bottom. Triethyl phosphate (1440 g) was introduced into the reactor at ambient temperature (25° C.). The set point of the thermostatically controlled bath was set at 50° C., the stirring was started up at a speed of 200 rpm (blade tip speed of 0.52 m/s) and the vapour condensation/reflux system was started.

Piezotech FC-20® (360 g) polymer, sold by Arkema, was introduced in powder form in one go into the reactor. Piezotech FC-20® is a polymer derived from VDF and TrFE monomers, comprising a molar proportion of TrFE relative to the sum of VDF and TrFE of the order of 20%. The MFI of the polymer was measured at 3.5 g/10 minutes at 230° C. under a 10 kg load, according to the standard ASTM D1238.

The stirring speed was increased to 400 rpm (blade tip speed of 1.05 m/s) once all the polymer had been introduced.

Half an hour after all the polymer had been introduced, the set point temperature of the thermostatically controlled bath was increased to 60° C.

Three hours after the end of the introduction of the powder, and under continuous staring, it was observed with the naked eye that the polymer was completely dissolved, forming a solution having a high viscosity (which creates air bubbles in the medium).

The polymer solution was recovered, hot, by draining from the reactor through the bottom valve.

The ink thus obtained, after rise of the air bubbles, is a transparent liquid with a viscosity between 18 000 and 30 000 mPa·s, measured precisely at 21 000 mPa·s, measured at ambient temperature (25° C.) using a Brookfield RVDV-II+P viscometer with spindle no. 7.

The solids content of the ink is measured by gravimetry in a ventilated oven, as indicated in the text above, to give a value close to the theoretical value of 18% by weight.

### Example 3: Comparative Example for Manufacturing a Solution of P(VDF-TrFE) in Triethyl Phosphate—Stirring Spindle: Magnetic Stirring Bar

The assembly used comprises a laboratory round-bottomed flask equipped with a magnetic stirring bar and placed in a heating bath stirrer. The round-bottomed flask is connected to a vapour condensation/reflux system.

Triethyl phosphate (610 g) was introduced into the round-bottomed flask at ambient temperature (25° C.). The temperature of the heating bath was then set at 80° C., the stirring was started up at a nominal speed of between 300 and 500 revolutions per minute.

The Piezotech FC-20® polymer powder (90 g) was added to the round-bottomed flask kept stirring and at a temperature of 80° C.

The time needed for complete dissolution of the polymer was 17 hours.

1. Process for manufacturing a solution of a fluoropolymer in a solvent,
the fluoropolymer being a polymer comprising units derived from vinylidene fluoride and also units derived from at least one other monomer of formula CX₁X₂=CX₃X₄, in which each X₁, X₂, X₃ and X₄ group is chosen independently from H, Cl, F, Br, I and alkyl groups comprising from 1 to 3 carbon atoms, which are optionally partially or completely halogenated,
the solvent having a boiling point above or equal to 150° C. at 1013 hPa and/or a saturation vapour pressure less than or equal to 5 hPa at 20° C.,
the process comprising a step of mixing said fluoropolymer with said solvent in a reactor having a stirring spindle comprising at least one blade, at a mixing temperature ranging from 40° C. to 100° C., and at a blade tip stirring speed of greater than or equal to 0.1 m/s, until said polymer has dissolved in said solvent;
the mixing step being carried out in the absence of a co-solvent of said fluoropolymer having a boiling point strictly below 150° C. at 1013 hPa and/or a saturation vapour pressure strictly greater than 5 hPa at 20° C.

2. Manufacturing process according to claim 1, in which said at least one other monomer is chosen from: vinyl fluoride (VF), trifluoroethylene (TrFE), tetrafluoroethylene (TFE), hexafluoropropene (HFP), trifluoropropenes, tetrafluoropropenes, hexafluoroisobutylene, perfluorobutylethylene, pentafluoropropenes, perfluoroalkyl vinyl ethers, bromotrifluoroethylene, 1-chloro-1-fluoroethylene (CFE), 1-chloro-2-fluoroethylene, chlorotrifluoroethylene (CTFE), 2-chloro-3,3,3-trifluoropropene (1233xf), 1-chloro-3,3,3-trifluoropropene, 1,2-dichloro-1,2-difluoroethylene, 1,1-dichloro-1,1-difluoroethylene and 1,1,2-trichloro-2-fluoroethylene.

3. Process according to claim 2, in which said fluoropolymer is chosen from: a P(VDF-TrFE), a P(VDF-TFE), a P(VDF-TrFE-TFE), a P(VDF-TrFE-CTFE), a P(VDF-TrFE-CFE), a P(VDF-TrFE-CTFE-CFE) and a P(VDF-TrFE-TFE-CTFE-CFE).

4. Process according to claim 1, in which said fluoropolymer has a melt flow index (MFI), measured according to the standard ASTM D1238, at 230° C. and under a 10 kg load, of from 0.2 g/10 min to 20 g/10 min.

5. Process according to claim 1, in which the solvent is chosen from the group consisting of: propylene glycol monomethyl ether acetate, N,N-dimethylformamide, cyclohexanone, N,N-dimethylacetamide, diacetone alcohol, diisobutyl ketone, 3-methylcyclohexanone, tetramethylurea, ethyl acetoacetate, dimethyl sulfoxide, trimethyl phosphate, diethylene glycol monoethyl ether, N-methyl-2-pyrrolidone, gamma-butyrolactone, isophorone, triethyl phosphate, carbitol acetate, propylene carbonate, dimethyl phthalate, and a mixture thereof.

6. Process according to claim 5, in which the solvent is gamma-butyrolactone or triethyl phosphate.

7. Process according to claim 1, in which said fluoropolymer represents from 1% by weight to 40% by weight of the total weight of the solution.

8. Process according to claim 1, in which said fluoropolymer represents more than 11% by weight relative to the total weight of solution; and/or less than 24% by weight relative to the total weight of solution.

9. Process according to claim 1, in which the mixing temperature is below or equal to 90° C.

10. Process according to claim 1, in which the blade tip stirring speed is greater than or equal to 0.25 m/s.

11. Process according to claim 1, in which the duration of the mixing step is between 30 minutes and 12 hours.

12. Process according to claim 1, in which the stirring spindle comprises at least three blades.

13. Process according to claim 1, in which the characteristic internal diameter D of the reactor relative to the stirring diameter L is such that: 0.2D≤L≤0.9D.

14. Process according to claim 1, in which the mixing step is carried out by addition of the fluoropolymer, in a single go or in portions, to the solvent.

15. Solution of a fluoropolymer in a solvent,
the fluoropolymer being a polymer comprising units derived from vinylidene fluoride and also units derived from at least one other monomer of formula CX₁X₂=CX₃X₄, in which each X₁, X₂, X₃ and X₄ group is chosen independently from H, Cl, F, Br, I and alkyl groups comprising from 1 to 3 carbon atoms, which are optionally partially or completely halogenated,
the solvent having a boiling point above or equal to 150° C. at 1013 hPa and/or a saturation vapour pressure less than or equal to 5 hPa at 20° C., wherein the solution does not comprise a co-solvent of said fluoropolymer having a boiling point strictly below 150° C. at 1013 hPa and/or a saturation vapour pressure strictly greater than 5 hPa at 20° C.

16. Solution according to claim 15, having a viscosity, as measured at 25° C. using a RVDV-II+P Brookfield viscometer, of from 2000 mPa·s to 40 000 mPa·s.

17. Solution of a fluoropolymer in a solvent,
the solvent having a boiling point above or equal to 150° C. at 1013 hPa and/or a saturation vapour pressure less than or equal to 5 hPa at 20° C., wherein the solution does not comprise a co-solvent of said fluoropolymer having a boiling point strictly below 150° C. at 1013 hPa and/or a saturation vapour pressure strictly greater than 5 hPa at 20° C.,
in which said fluoropolymer is according to claim 2.

18. Solution according to claim 15, according to which said fluoropolymer represents from 1% by weight to 40% by weight of the total weight of the solution.

19. Solution of a fluoropolymer in a solvent,
the fluoropolymer being a polymer comprising units derived from vinylidene fluoride and also units derived from at least one other monomer of formula CX₁X₂=CX₃X₄, in which each X₁, X₂, X₃ and X₄ group is chosen independently from H, Cl, F, Br, I and alkyl groups comprising from 1 to 3 carbon atoms, which are optionally partially or completely halogenated,
the solvent having a boiling point above or equal to 150° C. at 1013 hPa and/or a saturation vapour pressure less than or equal to 5 hPa at 20° C., wherein the solution does not comprise a co-solvent of said fluoropolymer having a boiling point strictly below 150° C. at 1013 hPa and/or a saturation vapour pressure strictly greater than 5 hPa at 20° C.,
wherein the solution is obtained according to the process according to claim 1.
